(19) United States
(12) Patent Application Publication
(10) Pub. No.: US 2017/0256925 A1
(43) Pub. Date: Sep. 7, 2017

(54) Medium-voltage cable joint

(71) Applicant: REPL International Limited, Swindon, Wiltshire (GB)

(72) Inventors: Rutton Homi PATEL, Swindon, Wiltshire (GB); Lorenzo PERETTO, Fratta Polesine (IT)

(21) Appl. No.: 15/519,738

(22) PCT Filed: Jul. 29, 2015
(86) PCT No.: PCT/EP2015/067442

§ 371 Date: Apr. 17, 2017

(30) Foreign Application Priority Data
Oct. 16, 2014 (GB) 1418388.3

(51) Int. Cl. H02G 1/14; H01B 9/00; H02G 15/18

(52) U.S. Cl. CPC H02G 1/14; H02G 15/1806; H01B 9/006

(57) ABSTRACT

A kit for joining opposing ends of two medium-voltage (between about 3.3 kV and about 52 kV) electrical power distribution cables, comprising an electrically-conductive connector for connecting the conductors of the cables, an electrically-insulating surround material for enveloping the connector, a partial discharge detector, comprising a generally cylindrical, electrically-conductive sheath around the insulating surround, from which an electrically-conductive element extends in an axial direction along the length of at least one of the cables, an outer protective tube for surrounding the remainder of the kit, wherein the conductive element is sufficiently long to project out of the protective tube. A partial discharge detector and a medium voltage cable run are also described.

### FIELD OF THE INVENTION

The present invention relates to joints in electrically insulated medium-voltage electrical power distribution cables.

### BACKGROUND ART

The electrical power industry uses four main voltage levels: Low Voltage is up to about 1 kV; Medium Voltage is between about 3.3 kV and about 52 kV; High-voltage is between about 72 kV and about 150 kV, and Extra-High Voltage is above about 220 kV. Medium voltage insulated, cables are commonly used for underground power distribution networks. They differ from extra-high or high-voltage air-insulated cables used for overhead transmission lines in that the conductor is surrounded by a number of electrically insulative, conductive and/or protective layers, usually including a dielectric insulating layer of (typically) a cross-linked polyethylene (XLPE), and a conductive earth sheath. These surrounding layers enable the cable to be buried safely, even in urban areas.

One known difficulty with such cables is in joining them in order to allow for longer cable runs or to effect repairs. A join requires that the insulating layer be removed in order to allow access to the conductors so that a good mechanical and electrical link can be made between them. However, medium-voltage cables create a strong electrical field around themselves, and an abrupt change in the surrounding dielectric will have the effect of concentrating that field. Care is therefore needed in order to avoid excessive field concentration, such as (for example) the arrangement shown in Dutch patent No. NL6514324A. Such connectors do however need to be assembled in situ, i.e. typically within a freshly excavated area and possibly during adverse weather and/or lighting conditions, meaning that perfect clean-room conditions are impossible. The inclusion of contaminants, voids, small misalignments and the like is therefore a distinct possibility.

The electric field around the cable is sufficient to initiate partial discharge, especially in locations where the field is concentrated. Partial discharge is a localised dielectric breakdown of a small portion of a solid or fluid electrical insulation system under medium voltage stress, which does not bridge the space between two conductors. Partial discharge often starts within gas voids, such as voids in solid insulation, between layers of insulation or around contaminants. Protracted partial discharge can erode solid insulation and leads eventually (and inevitably) to breakdown of the insulation and failure of the cable. The scope for partial discharge within the length of the cable can be reduced through good manufacturing practice, so now most cable failures take place at joints where the precise conditions of the joint have led to partial discharge and eventual failure.

Such a failure can be catastrophic, resulting in destruction of a localised section of cable. Location of the exact underground failure point is challenging, but urgent as the supply may be interrupted until the cable is repaired. Repair usually requires a short section of fresh cable to replace the damaged section, thus creating two new joints.

### SUMMARY OF THE INVENTION

At present, other than standard insulation tests, little is done to test a new joint. Care is taken to construct the joint correctly and as carefully as possible to avoid introducing possible locations for partial discharge, but once work is complete the joint is usually re-buried and the power re-connected. The initial insulation test should pick up any serious flaws, but will not find minor irregularities which may take weeks/months or even years to manifest themselves, and cause breakdown. A serious flaw in the joint will result in failure immediately or within hours or days, but a more minor flaw may take a considerable time to manifest itself. During this time, partial discharge is taking place and steadily enlarges the void (or other flaw) that has enabled it to happen, and thus a runaway process takes place until the insulation is so degraded that the cable fails catastrophically.

If it were possible to test the joint prior to burying it, then it could be confirmed that the joint met minimum quality standards and was thus likely to remain in service for a set period of time. A joint that did not meet these standards could be re-worked while the cable was exposed rather than having to re-excavate it. Equally, if ongoing monitoring of the joint were possible then developing problems could be detected, and the joint could be dealt with prior to failure at a time convenient to the network operator. Power could be re-routed during this work, avoiding outages. Repairs prior to failure would avoid the health & safety implications of a catastrophic failure. For each repair the amount of cable which has to be unburied is substantial; most joins include a cylindrical outer sleeve which has to be slid over one cable end before it is joined to the end of the other cable, and in medium voltage cables these cylindrical sleeves are of the order of 2 m long. Accordingly, it would be advantageous to be able to reduce the urgency with which repairs are required, and thus the need to excavate with urgency so as to reduce the risk that the cable, or other adjacent utility lines, might be accidentally damaged by the digging.

The present invention therefore provides a joint kit for joining opposing ends of two medium-voltage cables, comprising an electrically-conductive connector for connecting the conductors of the cables, an electrically-insulating surround material for enveloping the connector, a partial discharge detector, comprising an electrically-conductive member formable into a generally cylindrical, electrically-conductive sheath around the electrically-insulating surround, from which an electrically-conductive element extends in an axial direction along the length of at least one of the cables, an outer protective tube for surrounding the remainder of the kit, wherein the electrically-conductive element is sufficiently long to project out of the protective tube.

Likewise, the invention also relates to the partial discharge detector per se, i.e. one that comprises a generally cylindrical, electrically-conductive sheath from one end of which an electrically-conductive element extends in an axial direction.

In another aspect, the invention provides a medium-voltage cable run including a first section of medium-voltage cable and a second section of medium-voltage cable, each cable section including an inner electrically-conductive core surrounded by a solid, electrically-insulating material, the two cable sections being arranged end to end and being joined in a join comprising an electrically-conductive connector attached to the conductive cores of the cable sections, an electrically-insulating surround material enveloping the conductive connector, a partial discharge detector, comprising a generally cylindrical, electrically-conductive sheath around the insulating surround, from which an electrically-conductive element extends in an axial direction along the length of at least one of the cables, an outer protective tube surrounding the remainder of the join, wherein the conductive element projects out of the protective tube.

In these various aspects of the invention, a partial discharge detector is arranged or arrangeable around the butt joint between the cables and can be used to test and/or to monitor the join. The conductive sheath of the detector acts as an antenna to detect transient voltages induced by the current spikes in the conductor created by the partial discharge events. The sheath can be in the form of a cylinder with an axial slit therein, to aid in fitting the detector around the join and in sizing the detector to the exact dimensions of the join as made up in the field. A small gap between the opposing edges across the slit will in practice have little effect, although it is preferable for there to be no gap, which might be achieved by making the sheath slightly greater in circumference than that of the underlying insulating surround; in this way the sheath can be wrapped around the surround so that the edges of the slit overlap with no gap.

The partial discharge detector can have an insulating layer over a substantial part of its inner face, in order to protect the partial discharge detector by preventing any accidental contact between the detector and with any live parts or potentially live after assembly.

The conductive element is preferably flat, as this allows it to be exit the join area sandwiched between the cable and the outer protective tube. The outer protective tube itself can be a layer of heatshrink material, providing further electrical insulation and environmental sealing. Sealing around a flat conductor of this type is relatively straightforward, especially where the protective tube is coated on an inner face with an adhesive layer.

Such cables typically comprise screen wires located around the central conductor, outside the insulating layer but within or embedded in a further insulating layer. These wires may be arranged in a mesh pattern, and may be earthed. The joint kit ideally also comprises a second conductive connector for connecting these screen wires.

### BRIEF DESCRIPTION OF THE DRAWINGS

An embodiment of the present invention will now be described by way of example, with reference to the accompanying figures in which;

FIG. 1 is a side elevation view, in partial cross-section, of a joint between two cables;

FIG. 2 is another side elevation view similar to FIG. 1 and showing a partial discharge detector in accordance with the invention;

FIG. 3 is a side elevation view of the outside of a jointed cable, and

FIG. 4 is a perspective view of the partial discharge detector of FIG. 2.

### DETAILED DESCRIPTION OF THE EMBODIMENTS

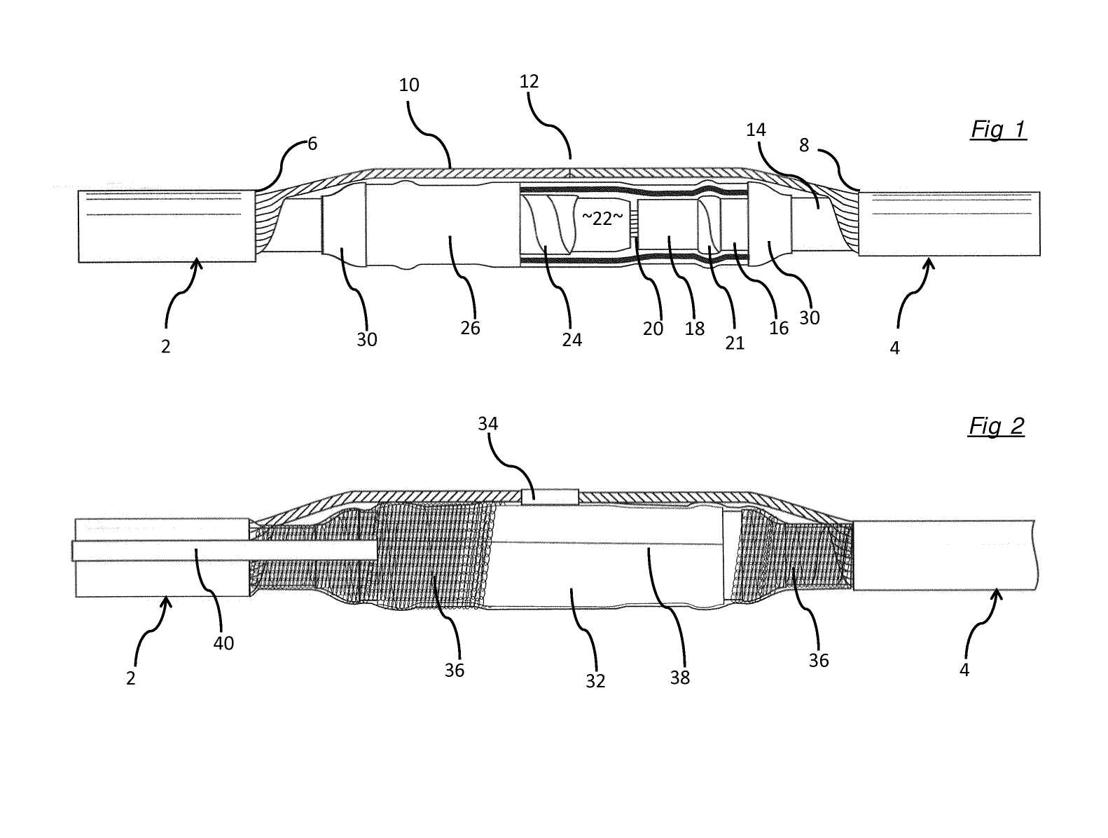

FIG. 1 shows a conventional joint between two cables 2, 4, each of which has a robust yet to some extent flexible, weather- and waterproof outer covering which is shown cut back to the points 6, 8 for the purposes of making the join. The cables are essentially identical, each comprises several layers and the join is substantially symmetrical along the axis of the cables (from left to right in the drawing); for clarity, some elements which are common to both cables or to both ends of the join are shown in the drawings and described below only in respect of one of the cables. Shown extending longitudinally between the cables 2, 4 and radially between the outer covering and an inner insulator 14, and rolled back so that the join is visible is a mesh of screening wires 10 which run the length of the cables 2, 4 and are joined (shown schematically at 12 so as to provide a continuous earth.

Underneath the outer sheath, each cable has a layer 16 which is a semi-conductive screen; this surrounds a cross-linked polyethylene (XLPE) insulation layer 18, which in turn surrounds the central conductor (not visible in FIG. 1, it lies underneath the stress control tube 20). Stress grading mastic 21 covers the end of the semi-conductive screen layer 16 and part of the XLPE layer 18. A mechanical connector 22 holds the two ends of the conductors from each cable in physical and electrical contact, and is coated in stress grading mastic 24 which is shown cut back but which in use extends continuously over the connector 22 and the XLPE layers 18 between the ends of the semi-conducive screen layer 16 of each cable 2, 4.

Surrounding the join is a core insulating bundle 26; to ensure a good join this is in the form of a cylinder, it is slid over one of the cables and, when the join between the conductors of the two cables 2, 4 has been made by the connector 22 and the stress grading mastic 24 applied, it is slid so as to overlie the join equally. The core insulating bundle 26 comprises several insulating layers (a central one is shown at 28), and is capped at each end with black sealing mastic 30 so as to seal the joint. Those skilled in the art will understand that the join inside the core insulation bundle may be packed with grease or other materials and that the whole bundle is heat shrunk and/or mechanically crimped so as to bind the layers of the join tightly together and to ensure that there are no air gaps.

FIG. 2 shows the cable join of FIG. 1 at a later stage of the joining process, in which the core insulation bundle 26 has been shrunk in place and capped at each end 30, and now incorporates an electrically conductive partial discharge detector 32 (shown in isolation in FIG. 4) closely surrounding and forming a sheath for the core insulation bundle 26. The mesh 10 of screening wires has been joined by a connector 34 at point 12, but it has not yet been rolled back around the join. A layer of black mastic 36 has been spread over the entire join (for clarity, part of this layer is omitted from the drawing) between the two ends 6, 8 of the outer sheath, covering the join and the detector 32. Detector 32 is in the form of a cylinder having a longitudinal slit 38; the cylinder is stretched open so that the slit 38 opens sufficiently for the core insulation bundle 26 to be inserted into the cylinder, which is then closed and crimped in place. The cylindrical detector 32 extends longitudinally so as to overlie the join at least as far (and preferably slightly further) as the ends of the semi-conductive screen 16. Extending from one end of the cylindrical detector 32 is a longitudinal conductor 40, which is flat and thin in the radial direction of the cables 2, 4 so as to ensure that the point where the conductor 40 pierces the layer of black mastic 36 is as impervious to the ingress of water or other contaminants as possible.

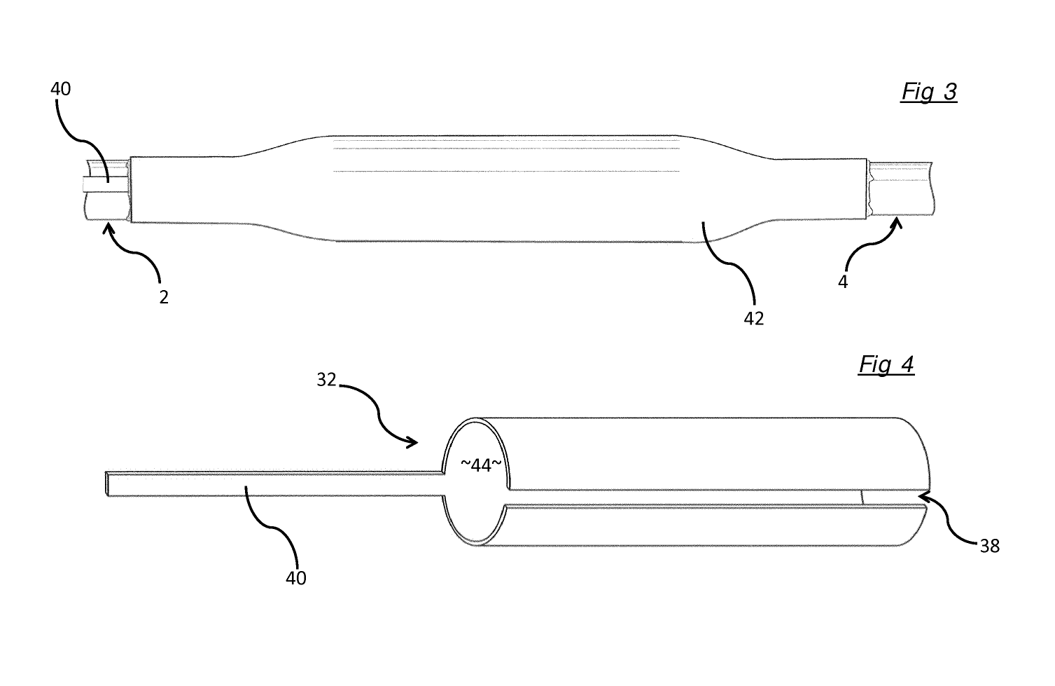

FIG. 3 shows the join of FIG. 4 completed by an outer sealing tube 42, which is packed with material to ensure there are no voids and heatshrunk or crimped in place and sealed in the conventional manner. Thus the finished join shown in FIG. 3 has an enlarged portion overlying the join and, at one end of the join a conductor 40.

In use, when the joined cables 2, 4 are “live” and carrying a medium voltage, if there are any inclusions or discontinuities as described above, there will be partial discharges (typically, sparks jump across a gas-filled void). When partial discharges occur there are high frequency transient current pulses and accompanying electromagnetic pulses; these pulses will be picked up by the detector 32 acting as a form of antenna, and electrical signals will be transmitted along the conductor 40; by monitoring the conductor 40 when the medium voltage cable has been buried and is in use, partial discharges can be picked up and measured to determine the seriousness of the partial discharges and the imminence of the failure of the join. A change in the absolute level of the signals could indicate that partial discharge is taking place but failure is some time away, and a constant signal level above a specific threshold could indicate that failure is imminent. The signals in the conductor 40 are monitored remotely (either by hard link or wirelessly).

FIG. 4 shows the detector 32, which comprises a unitary cylinder, or sheath, with a longitudinally extending element 40, formed of a conductive material, such as metal or alloy, in solid or mesh form. The material of which the detector is formed can be resilient, so as to be deformable to allow assembly and to spring back into shape when assembled, or it can be of a malleable material allowing the detector to be wrapped around the join to form a sheath, and then be held in place by the outer sealing tube 42 and/or an adhesive provided between the detector 32 and the core insulation bundle 26. As described above, if resilient the detector 32 is bent open so as to widen the slit 38 enough so the core insulation bundle 26 can be inserted into the cylinder, then the cylinder is crimped so that it clamps around the cable join and the edges of the slit overlap. The inner surface 44 of part or all of the cylindrical part of the cylinder may be provided with an insulating and/or adhesive layer, which may also extend along all or part of the longitudinal element 40; the presence of insulation here protects the detector 32 from coming into electrical contact with any potentially live parts, such as the central conductor or the mesh of screening wires 10.

Most power distribution cables are employed to carry three-phase AC power. In this case, there will then be a set of three cables 2, 4 located generally alongside each other and often within a common conduit. To join such a group of cables, three joints are required, one for each opposing pair of cables, of which some or (preferably) all are of the type described above.

It will of course be understood that many variations may be made to the above-described embodiment without departing from the scope of the present invention. For example, the invention has been described in connection with cables containing only a single conductor; those skilled in the art will understand how the invention could be modified for use with multi-conductor cables. The partial discharge detector has been described as a cylinder having a slit which is longitudinal; provided that the partial discharge detector can closely surround the core insulation bundle, it can have any tubular shape provided it fits tightly to and surrounds the core insulation bundle, or it could be flat and of a malleable material so as to be foldable to fit around the core insulation bundle 26; the term “generally cylindrical” should be construed herein as meaning a shape which in use is substantially cylindrical about a substantially cylindrical core insulation bundle, if the core insulation bore deviated from the strictly cylindrical (being oval in cross-section, for example) then the detector sheath should follow the same general shape. There could be any configuration of slit, it could be helical or any other shape, and/or the edges of the slit need not be parallel or even straight provided they overlap, one or both edges could be of zigzag or sawtooth shape for example—or there need not be a slit at all, the detector 32 could be a complete cylinder, and slid over the core insulation bundle in the same way that the core insulation bundle is slid over the join. The conductor 40 is described as extending longitudinally, i.e. parallel with the cables 2, 4; the conductor could emerge from the cable join at any angle (provided this does not prejudice the watertight integrity of the join), though it is convenient for it to be substantially parallel to the cables as these then provide a measure of mechanical support and/or protection to the adjoining conductor. Furthermore, where different variations or alternative arrangements are described above, it should be understood that embodiments of the invention may incorporate such variations and/or alternatives in any suitable combination.

1. A joint kit for joining opposing ends of two medium-voltage cables, comprising;
an electrically-conductive connector for connecting the conductors of the cables;
an electrically-insulating surround material for enveloping the connector;
a partial discharge detector, comprising an electrically-conductive member formable into a generally cylindrical conductive sheath around the insulating surround, from which an electrically-conductive element extends in an axial direction along the length of at least one of the cables;
an outer protective tube for surrounding the remainder of the kit, wherein the conductive element is sufficiently long to project out of the protective tube.

2. A joint kit according to claim 1 in which the conductive sheath is in the form of a cylinder with an axial slit therein.

3. A joint kit according to claim 1 or claim 2 in which the conductive element is flat.

4. A joint kit according to any one of the preceding claims in which the partial discharge detector has an insulating layer over a substantial part of its inner face.

5. A joint kit according to any one of the preceding claims in which the protective tube is a heat-shrink material.

6. A joint kit according to any one of the preceding claims in which the protective tube is coated on an inner face with an adhesive layer.

7. A joint kit according to any one of the preceding claims, further comprising a second conductive connector for connecting screen wires of the two medium-voltage cables.

8. A medium-voltage cable run including a first section of medium-voltage cable and a second section of medium-voltage cable, each cable section including an inner conductive core surrounded by a solid insulating material, the two cable sections being arranged end to end and being joined in a join comprising;
an electrically-conductive connector attached to the conductive cores of the cable sections;
an electrically-insulating surround material enveloping the conductive connector;
a partial discharge detector, comprising a generally cylindrical, electrically-conductive sheath around the insulating surround, from which a conductive element extends in an axial direction along the length of at least one of the cables;
an outer protective tube surrounding the remainder of the join, wherein the conductive element projects out of the protective tube.

9. A medium-voltage cable run according to claim 8 in which the conductive sheath is in the form of a cylinder with an axial slit therein.

10. A medium-voltage cable run according to claim 8 or claim 9 in which the conductive element is flat.

11. A medium-voltage cable run according to any one of claims 8 to 10 in which the partial discharge detector has an insulating layer over a substantial part of its inner face.

12. A medium-voltage cable run according to any one of claims 8 to 11 in which the protective tube is a heat-shrunk material.

13. A medium-voltage cable run according to any one of claims 8 to 12 in which the protective tube is coated on an inner face with an adhesive layer.

14. A medium-voltage cable run according to any one of claims 8 to 13, wherein the two medium-voltage cables include screen wires arranged, around the insulating surround material which, in the vicinity of the join, are gathered together and connected via a second conductive connector.

15. A partial discharge detector, comprising a generally cylindrical, electrically-conductive sheath from one end of which an electrically-conductive element extends in an axial direction.

16. A partial discharge detector according to claim 15 in which the conductive sheath is in the form of a cylinder with an axial slit therein.

17. A partial discharge detector according to claim 15 or claim 16 in which the conductive element is flat.

18. A partial discharge detector according to any one of claims 15 to 17 in which the partial discharge detector has an insulating layer over a substantial part of its inner face.

19. A partial discharge detector for a join between medium-voltage cables, substantially as herein described with reference to and/or as illustrated in the accompanying drawings.
